(19) United States
(12) Patent Application Publication
(10) Pub. No.: US 2011/0292168 A1
(43) Pub. Date: Dec. 1, 2011

(54) 3D VISION MONITOR, SYSTEM, AND DISPLAY PARAMETER ADJUSTING METHOD THEREOF

(75) Inventors: Wei-Heng Huang, Taipei Hsien (TW); Chueh-Pin Ko, Taipei Hsien (TW)

(73) Assignee: ACER INCORPORATED, Taipei Hsien (TW)

(21) Appl. No.: 12/880,178

(22) Filed: Sep. 13, 2010

(30) Foreign Application Priority Data
May 27, 2010 (TW) 99117029

(51) Int. Cl. H04N 17/02; H04N 13/00

(52) U.S. Cl. 348/42; 348/E13.001; 348/189

(57) ABSTRACT

The present invention discloses a 3D vision monitor, system, and display parameter adjusting method thereof. In one embodiment, the 3D vision monitor judges whether the image signal is a 3D image according to a synchronous clock signal of the image signal. While the 3D vision monitor confirms the image signal is a 3D image, it adjusts the brightness, the red gain value, the green gain value, or the blue gain value of the image signal. In another embodiment, a computer executes the 3D vision program and generates a trigger signal. Then, according to the trigger signal, the 3D vision monitor increases the brightness, the red gain value, the green gain value, or the blue gain value of the image signal.

### CROSS-REFERENCE TO RELATED APPLICATION

This application claims the priority benefit of Taiwan application serial no. 99117029, filed on May 27, 2010. The entirety of the above-mentioned patent application is hereby incorporated by reference herein and made a part of this specification.

### FIELD OF THE INVENTION

The exemplary embodiment(s) of the present invention relates to a 3D vision monitor, system, and display parameter adjusting method. More specifically, the exemplary embodiment(s) of the present invention relates to a display technology of automatically adjusting display brightness or color cast.

### BACKGROUND OF THE INVENTION

3D vision monitors have become popular at present. The principle is that users see different images from their left and right eyes, and synthesize a 3D image in their brains. To achieve this effect, some 3D display system requires users to wear 3D glasses, and there are two different types of 3D glasses: active and passive ones. The 3D active glasses can receive the synchronous signal from a 3D vision monitor. While the 3D vision monitor displays a left-eye image, the 3D active glasses cover the right eye so that the user sees the display content of the 3D vision monitor only by his/her left eye. Similarly, while the 3D vision monitor displays a right-eye image, the 3D active glasses cover the left eye and the user can only see the content of the 3D display by his/her right eye. Thus, it allows users to experience 3D images. As for the 3D passive glasses, the left and right eyeglass has different optical properties respectively, such as polarization of light or color cast. Also, the 3D vision monitor can simultaneously display the left-eye and right-eye image according to different optical properties. Therefore, when the user wears the 3D passive glasses to watch the 3D images of the 3D vision monitor, the left eye receives different images from those received by the right eye, which allows users to experience 3D images.

However, the above-mentioned 3D vision mechanisms combined with 3D glasses reduce the brightness of images, or have the color cast side effect, resulting in negative experience when user watches 3D images.

### SUMMARY OF THE INVENTION

A primary object of the present invention is to provide a 3D vision monitor, system, and display parameter adjusting method, so as to improve users' experience when they watches 3D images.

According to an object of the present invention, a display parameter adjusting method of a 3D vision monitor is provided, comprising the following steps. At first, the 3D vision monitor receives an image signal. According to a synchronous clock signal of the image signal, the 3D vision monitor judges whether the image signal is a 3D image. Next, when the 3D vision monitor confirms the image signal is a 3D image, it adjusts the brightness, the red gain value, the green gain value, or the blue gain value.

According to the object of the present invention, another display parameter adjusting method of a 3D vision monitor is provided, comprising the following steps. To begin with, a 3D vision monitor is electrically connected to a computer. Then, the computer executes a 3D vision program to play the 3D image contents. Meanwhile, the computer or the 3D vision monitor automatically adjusts the brightness, the green gain value, or the blue gain value of the 3D image contents of the 3D vision monitor.

The method further comprises the following steps. A display card of the computer outputs a display signal to the 3D vision monitor. While the computer executes the 3D vision program, the computer generates a trigger signal. Next, according to the trigger signal, the display card adjusts the brightness, the red gain value, the green gain value, or the blue gain value of the display signal.

In addition, the method further comprises the following steps. The computer generates a trigger signal by executing the 3D vision program. Then, the 3D vision monitor receives the trigger signal. According to the trigger signal, the 3D vision monitor adjusts the brightness, the red gain value, the green gain value, or the blue gain value of the 3D image.

According to an object of the present invention, a 3D vision monitor is provided, comprising a display module, a signal reception module, and a signal processing module. The signal reception module receives an image signal. According to a synchronous clock signal of the image signal, the signal processing module judges whether the image signal is a 3D image. Next, if the signal processing module confirms the image signal is a 3D image, it adjusts the brightness, the red gain value, the green gain value, or the blue gain value of the image signal of the display module.

According to the object of the present invention, a 3D vision system is further provided, comprising a computer, a 3D vision monitor. The computer executes a 3D vision program to play the 3D image contents and generates a trigger signal. The 3D vision monitor is electrically connected to the computer. According to the trigger signal, the computer or the 3D vision monitor automatically adjusts the brightness, the green gain value, or the blue gain value of the 3D image contents of the 3D vision monitor.

In addition, the computer transmits the trigger signal to the 3D vision monitor through a display data channel.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of a 3D vision system according to a first embodiment of the present invention;

FIG. 2 is a block diagram of a 3D vision system according to a second embodiment of the present invention;

FIG. 3 is a block diagram of a 3D vision monitor according to an embodiment of the present invention;

FIG. 4 is a flowchart of the first embodiment showing the steps included in a display parameter adjusting method of a 3D vision monitor according to the method of the present invention;

FIG. 5 is a flowchart of the first embodiment showing the steps included in a display parameter adjusting method of a 3D vision system according to the method of the present invention; and

FIG. 6 is a flowchart of the second embodiment showing the steps included in a display parameter adjusting method of a 3D vision system according to the method of the present invention.

### DETAILED DESCRIPTION OF THE PREFERRED EMBODIMENTS

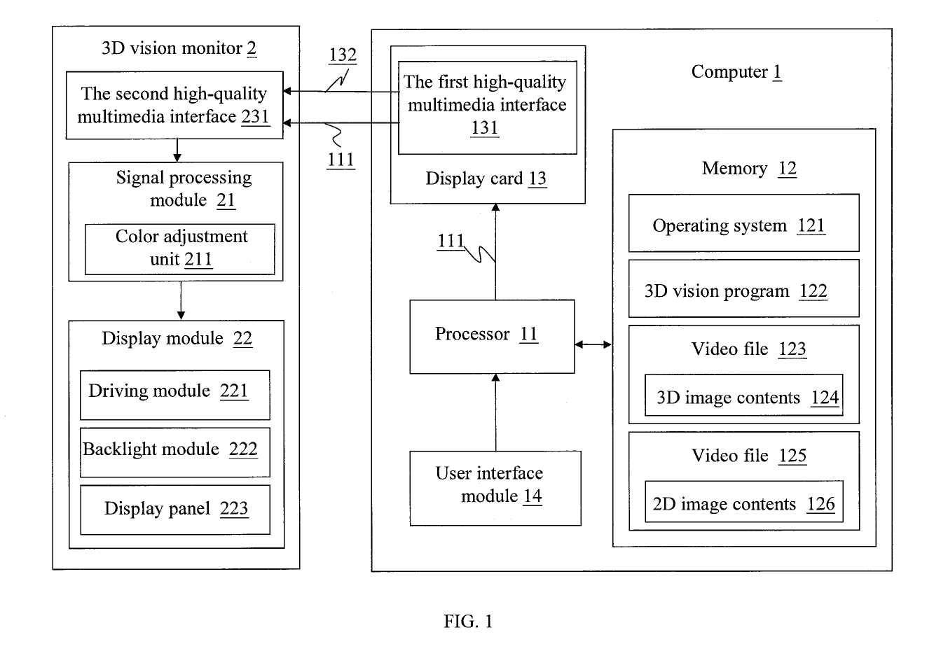

Please refer to FIG. 1. That is a block diagram of a 3D vision system according to a first embodiment of the present invention. As shown, the 3D vision system comprises a computer 1 and a 3D vision monitor 2. The computer 1 comprises a processor 11, a memory 12, a display card 13, and a user interface module 14. The memory 12 stores an operating system 121, a 3D vision program 122, a video file 123 and a video file 125. The operating system 121 and the 3D vision program 122 are the programs which can be executed by the processor 11. The Video file 123 comprises 3D image contents 124, and the video file 125 comprises 2D image contents 126. The processor 11 gets the operating system 121 from the memory 12 and then executes it. The operating system 121 under execution process is used for managing the software and hardware resources of the computer 1. For example, it allocates the usable memory block address, output/input port, or video/audio outputting mechanism of the application programs. While users would like to play video contents, the computer 1 controlled by the user interface module 14 executes the 3D vision program 122 to process the video files to obtain the image contents. Then, the processor 11 transmit image contents to the display card 13, and the display card 13 transforms the image contents into image signals 132 which can be processed by the 3D vision monitor 2. Later on, the image signals 132 are transmitted to the 3D vision monitor 2 through the first high-quality multimedia interface 131.

In the embodiment, the memory 12 stores a video file 123 comprising 3D image contents 124 and a video file 125 comprising 2D image contents 126. While the 3D vision program 122 confirms the image contents are 3D image contents 124, the processor 11 generates a trigger signal 111. Meanwhile, the trigger signal 111 is transmitted to the 3D vision monitor 2 through the first high-quality multimedia interface 131. The 3D vision monitor 2 comprises the second high-quality multimedia interface 231, signal processing module 21, and a display module 22. The second high-quality multimedia interface 231 is electrically connected with the first high-quality multimedia interface 131 of the computer 1 to receive the image signals 132 and the trigger signal 111. The signal processing module 21 processes the image signals 132 and directs the display module 22 to display the processed image signals 132. The display module 22 comprises a driving module 221, a backlight module 222 and a display panel 223. The driving module 221 inputs image signals 132 into the display panel 223 and drives the display panel 223 to display image signals 132. The backlight module 222 emits visible light, and the visible light penetrates the display panel 223 to the user so he/she can see the display content on the display panel 223. In addition, the display module 22 could be a LCD monitor. Also, the backlight module 222 and the display module 22 could be a self-luminescence display panel, such as an organic light-emitting diode panel or a plasma panel.

When the signal processing module 21 receives the trigger signal 111, it indicates that the received image signals 132 are 3D image contents 124. The user needs to wear 3D glasses to watch the 3D image contents 124. From the above description, 3D glasses reduce the brightness or color of the images. Thus, the signal processing module 21 automatically control the backlight module 222 to enhance the luminous intensity to improve the brightness of the images. Alternately, the color adjustment unit 211 of signal processing module 21 increases the red gain value, the green gain value, or the blue gain value of image signals 132 to improve the color cast phenomenon.

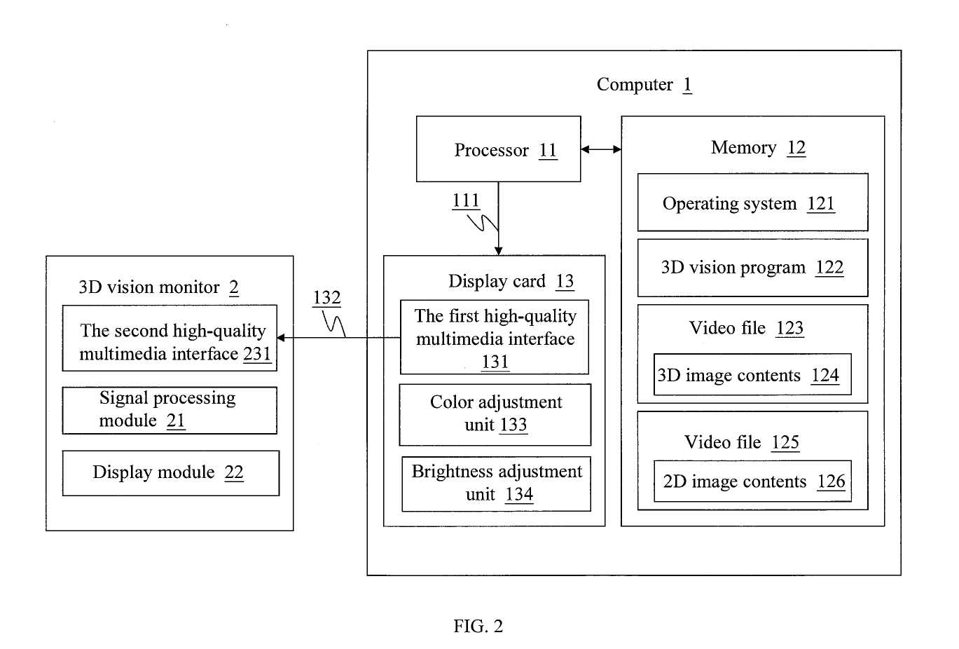

Please refer to FIG. 2. That is a block diagram of a 3D vision system according to a second embodiment of the present invention. As shown, the different part of the second embodiment from the first embodiment is that the display card 13 adjusts the brightness or color of the images. When the display card 13 receives the trigger signal 111, it indicates that the 3D vision program 122 has opened the video file 123 with 3D image contents 124. In order to improve the users' viewing quality, the brightness adjustment unit 134 of display card 13 increases the brightness of image signals 132. Also, the color adjustment unit 211 adjusts the red gain value, the green gain value, or the blue gain value of image signals. Then, the 3D vision monitor 2 receives the image signals 132 and plays the image signals 132 in 3D mode.

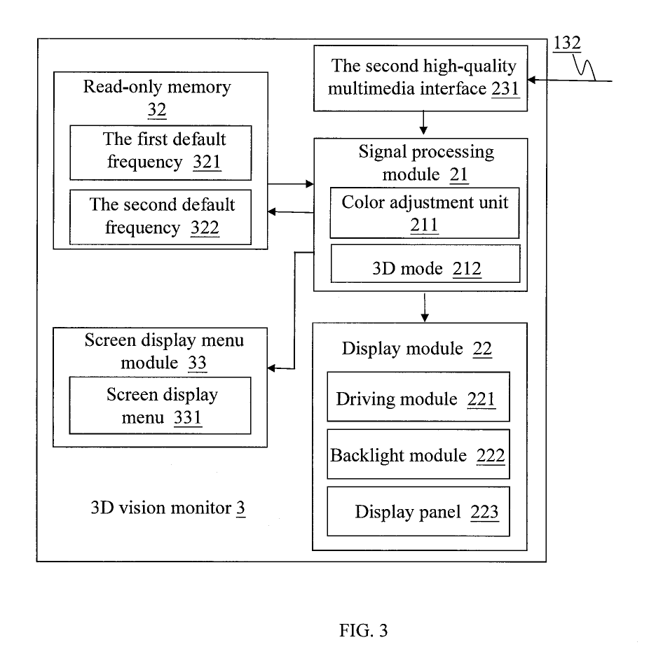

Please refer to FIG. 3. That is a block diagram of a 3D vision monitor according to an embodiment of the present invention. In this figure, 3D vision monitor comprises a signal processing module 21, a display module 22, a read-only memory 32, a second high-quality multimedia interface 231, and a screen display menu module 33. The signal processing module 21 receives image signals 132 through the second high-quality multimedia interface 231. As 3D images comprise the left-eye images and the right-eye images, faster synchronous clock signals are required. Hence, the signal processing module 21 can judging whether the image signals are 3D images according to the synchronous clock signals of the image signals 132. For example, the signal processing module 21 can compare the synchronous clock signals of the image signals with the first default frequency 321 and the second default frequency 322 stored in read-only memory 32. The first default frequency 321 is twice the second default frequency 322. If the synchronous clock frequency of the image signals 132 is close to the second default frequency 322, it indicates that the contents of the image signals are 2D images. On the contrary, if the synchronous clock frequency of the image signals 132 is close to the first default frequency 321, it indicates that the contents of the image signals are 3D images.

While the signal processing module 21 confirms the image contents of the image signals are 3D images according to the synchronous clock signals of the image signals 132, it means that users need to wear 3D glasses to watch the 3D images. From the above description, 3D glasses reduce the brightness or color of the images. Thus, the signal processing module 21 automatically control the backlight module 222 to enhance the luminous intensity to improve the brightness of the images. Alternately, the color adjustment unit 211 of signal processing module 21 increases the red gain value, the green gain value, or the blue gain value of image signals 132 to improve the color cast phenomenon. Moreover, the screen display menu module 33 generates a screen display menu 331, and it shows on display module 22 for users to activating a 3D mode 212. When a user manually activates the 3D mode 212, the signal processing module 21 control the backlight module 222 to enhance the luminous intensity to improve the brightness of the images. Alternately, the color adjustment unit 211 of signal processing module 21 increases the red gain value, the green gain value, or the blue gain value of image signals 132.

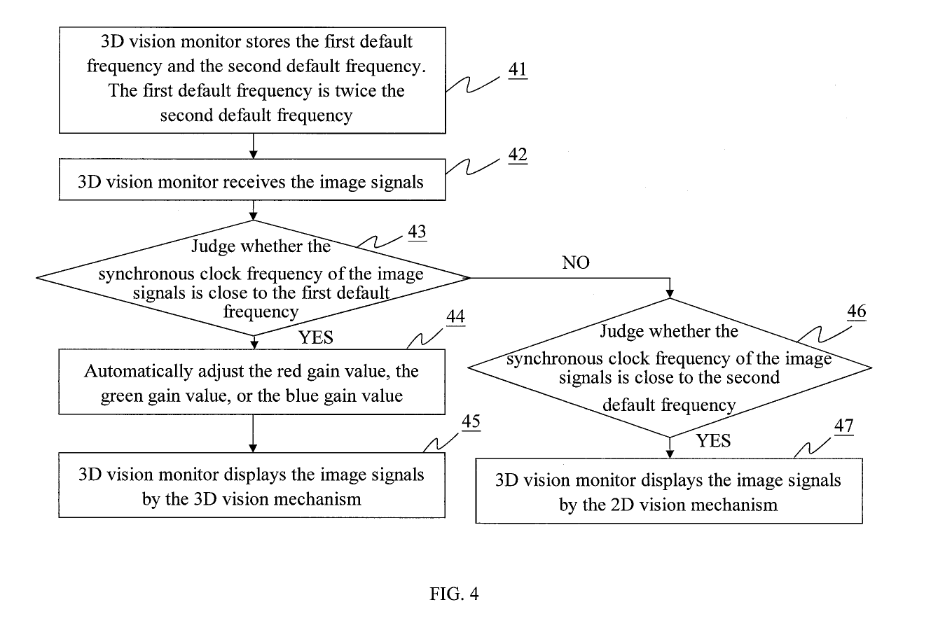

Please refer to FIG. 4. That is a flowchart of a first embodiment showing the steps included in a display parameter adjusting method of a 3D vision monitor according to the method of the present invention. As shown, the flowchart of the first embodiment comprises the following steps. In step S41, a 3D vision monitor stores the first default frequency and the second default frequency. The first default frequency is twice the second default frequency. In step S42, the 3D vision monitor receives the image signals. In step S43, the 3D vision monitor judges whether the synchronous clock frequency of the image signals is close to the first default frequency. If yes, to step S44, the 3D vision monitor automatically adjusts the red gain value, the green gain value, or the blue gain value. Then, in step S45, the 3D vision monitor displays the image signals by the 3D vision mechanism. If no, to step S46, the 3D vision monitor judges whether the synchronous clock frequency of the image signals is close to the second default frequency. If yes, in step S47, the 3D vision monitor displays the image signals by the 2D vision mechanism.

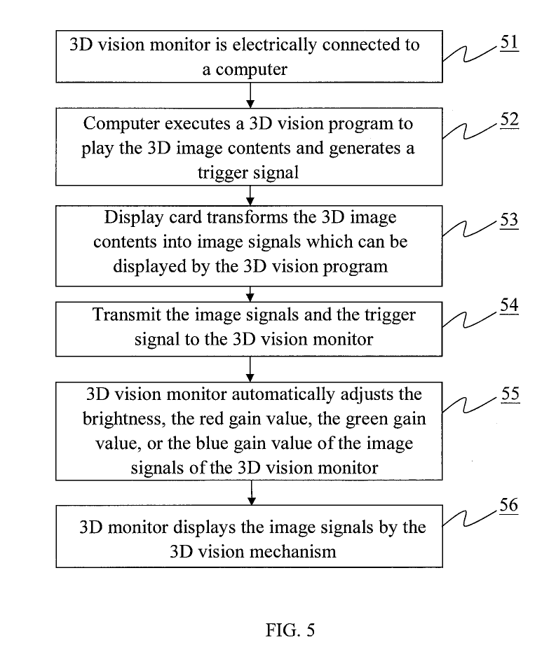

Please refer to FIG. 5. That is a flowchart of the first embodiment showing the steps included in a display parameter adjusting method of a 3D vision system according to the method of the present invention. As shown, the flowchart of the first embodiment comprises the following steps. At first, in step S51, a 3D vision monitor is electrically connected to a computer. Next, in step S52, the computer executes a 3D vision program to play the 3D image contents and generates a trigger signal. In step S53, the display card of the computer transforms the 3D image contents into image signals which can be displayed by the 3D vision program. Then, in step S54, the computer transmits the image signals and the trigger signal to the 3D vision monitor. In step S55, the 3D vision monitor automatically adjusts the brightness, the red gain value, the green gain value, or the blue gain value of the image signals of the 3D vision monitor. Afterward, in step S56, the 3D monitor displays the image signals by the 3D vision mechanism.

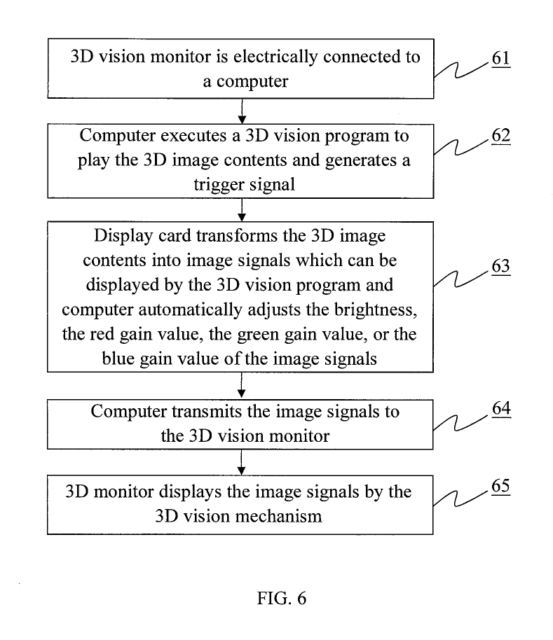

Please refer to FIG. 6. That is a flowchart of the second embodiment showing the steps included in a display parameter adjusting method of a 3D vision system according to the method of the present invention. As shown, the flowchart of the second embodiment comprises the following steps. To begin with, in step S61, a 3D vision monitor is electrically connected to a computer. In step S62, the computer executes a 3D vision program to play the 3D image contents and generates a trigger signal. Soon, in step S63, the display card of the computer transforms the 3D image contents into image signals which can be displayed by the 3D vision program. The computer automatically adjusts the brightness, the red gain value, the green gain value, or the blue gain value of the image signals. In step S64, the computer transmits the image signals to the 3D vision monitor. Afterward, in step S65, the 3D monitor displays the image signals by the 3D vision mechanism.

Briefly, the techniques above-mentioned is to increase the brightness, the red gain value, the green gain value, or the blue gain value of the image signals to improve the users' experience when they watch 3D images. In addition, the method used depends on the format of 3D images. If the 3D image contents have the format of left and right eye images interlaced placed, the technique would mainly focus on increasing the brightness of the image signals. If the 3D image contents have the format of left and right eye images color cast, the technique would mainly focus on increasing the red gain value, the green gain value, or the blue gain value of the image signals. Also, the brightness and the gain values of the three colors can be increased at the same time.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A display parameter adjusting method of a 3D vision monitor, comprising the following steps:
receiving an image signal by the 3D vision monitor;
judging whether the image signal is a 3D image according to a synchronous clock signal of the image signal; and
adjusting a brightness, a red gain value, a green gain value, or a blue gain value of the 3D vision monitor when confirming the image signal is the 3D image.

2. The display parameter adjusting method of a 3D vision monitor as claimed in claim 1, further comprising the following steps:
providing a screen display menu for users to set the 3D vision monitor into a 3D vision mode; and
increasing the brightness, the red gain value, the green gain value, or the blue gain value of the 3D vision monitor when the 3D vision monitor is set for the 3D vision mode.

3. A display parameter adjusting method of a 3D vision system, comprising the following steps:
electrically connecting a 3D vision monitor to a computer;
executing a 3D vision program to play a plurality of 3D image contents by the computer; and
automatically adjusting a brightness, a green gain value, or a blue gain value of the 3D image contents of the 3D vision monitor.

4. The display parameter adjusting method of a 3D vision system as claimed in claim 3, further comprising the following steps:
outputting a display signal to the 3D vision monitor by a display card of the computer;
generating a trigger signal while the computer executing the 3D vision program; and
adjusting the brightness, a red gain value, the green gain value, or the blue gain value of the display signal by the display card according to the trigger signal.

5. The display parameter adjusting method of a 3D vision system as claimed in claim 4, further comprising the following steps:
generating the trigger signal while the computer executing the 3D vision program;
receiving the trigger signal by the 3D vision monitor; and
adjusting the brightness, the red gain value, the green gain value, or the blue gain value of a 3D image by the 3D vision monitor according to the trigger signal.

6. The display parameter adjusting method of a 3D vision system as claimed in claim 5, wherein the computer transmits the trigger signal to the 3D vision monitor through a display data channel.

7. A 3D vision monitor, comprising:
a display module;
a signal reception module receiving an image signal; and
a signal processing module judging whether the image signal is a 3D image according to a synchronous clock signal of the image signal, and adjusting a brightness, a red gain value, a green gain value, or a blue gain value of the image signal of the display module when confirming the image signal is the 3D image.

8. The 3D vision monitor as claimed in claim 7, wherein the 3D vision monitor further comprises a on-screen display module generating a screen display menu for users to set the 3D vision monitor into a 3D vision mode; the signal processing module increasing the brightness, the red gain value, the green gain value, or the blue gain value of the display module while the 3D vision monitor in the 3D vision mode.

9. A 3D vision system, comprising:
a computer executing a 3D vision program to play a plurality of 3D image contents and generating a trigger signal; and
a 3D vision monitor electrically connecting to the computer and automatically adjusting a brightness, a green gain value, or a blue gain value of the 3D image contents of the 3D vision monitor according to the trigger signal.

10. The 3D vision system as claimed in claim 9, wherein the computer transmits the trigger signal to the 3D vision monitor through a display data channel.
